(19) United States
(12) Patent Application Publication
(10) Pub. No.: US 2013/0251819 A1
(43) Pub. Date: Sep. 26, 2013

(54) Method of Reducing Microbes on Food

(71) Applicant: Jones-Hamilton Co., Walbridge, OH (US)

(72) Inventors: Carl J. Knueven, Bowling Green, OH (US); Robert S. Taylor, Weatherford, TX (US)

(73) Assignee: Jones-Hamilton Co., Walbridge, OH (US)

(21) Appl. No.: 13/897,681

(22) Filed: May 20, 2013

Related U.S. Application Data
(62) Division of application No. 13/179,507, filed on Jul. 9, 2011.
(60) Provisional application No. 61/362,796, filed on Jul. 9, 2010.
(60) Provisional application No. 61/365,035, filed on Jul. 16, 2010.

(51) Int. Cl. A23L 3/358

(52) U.S. Cl. CPC A23L 3/358
USPC 424/616

(57) ABSTRACT

An antimicrobial composition useful for microbial reduction on food includes an oxidizer and an acid component. The oxidizer includes hydrogen peroxide and/or peroxyacetic acid. The acid component includes one or more inorganic acids or their salts. For example, the acid component may be selected from sodium acid sulfate, sulfuric acid, hydrochloric acid, phosphoric acid, sulfamic acid, nitric acid, hydrofluoric acid, or combinations thereof. In certain embodiments, the antimicrobial composition additionally includes one or more surfactants. A method of reducing microbes on food includes applying to the food the above-described antimicrobial composition.

### CROSS-REFERENCE TO RELATED APPLICATIONS

This application is a divisional of U.S. Utility application Ser. No. 13/179,507, filed Jul. 9, 2011, which claims the benefit of U.S. Provisional Application No. 61/362,796, filed Jul. 9, 2010, and U.S. Provisional Application No. 61/365,035, filed Jul. 16, 2010, the disclosures of which are incorporated herein by reference.

### BACKGROUND OF THE INVENTION

This invention relates in general to antimicrobial compositions, and in particular to antimicrobial compositions for treating foods such as meats, fruits or vegetables.

Before foods are consumed they may be contaminated with microbes that make them unsuitable or undesirable for consumption. For example, the microbes may come from the food itself, from contact surfaces during processing of the food, and/or from the surrounding environment. The microbes can range from pathogenic microbes to spoilage organisms that can affect the taste, color, and/or smell of the food.

Food processors use a variety of methods during processing to reduce microbes on foods. These methods include cleaning and sanitizing the processing plant environment, applying an antimicrobial composition to the food, irradiating or applying heat to the food, and others.

Applying an antimicrobial composition to the food is a preferred way of reducing microbes. However, it is difficult to formulate a composition that is effective at reducing microbes using ingredients that are acceptable for direct contact with food according to government regulations. Further, it is difficult to formulate a composition that can be applied directly to food without adversely affecting its color, taste or smell.

A variety of antimicrobial compositions are known for use during the processing of foods. However, there is still a need for improved antimicrobial compositions for foods.

### SUMMARY OF THE INVENTION

The invention relates to an antimicrobial composition useful for microbial reduction on food comprising an oxidizer and an acid component. The oxidizer comprises hydrogen peroxide and/or peroxyacetic acid. The acid component comprises one or more inorganic acids or their salts. For example, the acid component may be selected from sodium acid sulfate, sulfuric acid, hydrochloric acid, phosphoric acid, sulfamic acid, nitric acid, hydrofluoric acid, or combinations thereof. In certain embodiments, the antimicrobial composition additionally comprises one or more surfactants. In certain embodiments, the oxidizer is hydrogen peroxide included in a solution for application to the food, in an amount from about 10 ppm to about 2500 ppm of the solution. Also, in certain embodiments, the acid component is included in a solution for application to the food in an amount sufficient to achieve a pH of the solution within a range of from about pH 1 to about pH 9.

The invention also relates to a method of reducing microbes on food comprising applying to the food an antimicrobial composition. The antimicrobial composition comprises an oxidizer and an acid component. The acid component comprises one or more inorganic acids or their salts. In certain embodiments, the antimicrobial composition is applied to meat during processing of the meat, and in other embodiments it is applied to fruits or vegetables.

Various aspects of this invention will become apparent to those skilled in the art from the following detailed description of the preferred embodiments.

### DETAILED DESCRIPTION OF THE PREFERRED EMBODIMENTS

The present invention relates to an antimicrobial composition useful for microbial reduction on food, and to a method of reducing microbes on food by applying the antimicrobial composition.

The antimicrobial composition comprises an oxidizer and an acid component. The oxidizer is hydrogen peroxide, peroxyacetic acid, or a combination of these materials. It was found that a combination of these oxidizers with the acid component described below is effective at reducing microbes on food without adversely affecting the qualities of the food. The use of hydrogen peroxide as the oxidizer has particular advantages versus peroxyacetic acid.

The oxidizer is included in the antimicrobial composition in any suitable amount. In certain embodiments, when the antimicrobial composition is in solution for application to the food, the oxidizer is hydrogen peroxide included in an amount within a range of from about 10 ppm to about 2500 ppm of the solution, and in some particular examples from about 50 ppm to about 110 ppm of the solution.

The acid component comprises one or more inorganic acids or their salts. Any suitable inorganic acids can be used. Some examples of inorganic acids that may be used include sulfuric acid, hydrochloric acid, phosphoric acid, sulfamic acid, nitric acid, hydrofluoric acid, or combinations of these acids. In certain embodiments, the inorganic acid is a food grade acid.

Also, any suitable salts of inorganic acids can be used. In certain embodiments, these are alkali metal salts. The alkali metal salts of inorganic acids convert to acids when hydrated with sufficient water. Some examples of alkali metals include sodium, potassium and lithium, and some examples of inorganic acids include sulfate, phosphate and nitrate. In certain embodiments, the metal salts are alkali metal bisulfates which include, for example, sodium bisulfate (i.e., sodium acid sulfate or sodium hydrogen sulfate), potassium bisulfate (i.e., potassium acid sulfate or potassium hydrogen sulfate), or mixtures thereof.

Food grade sodium acid sulfate is manufactured and sold as pHase™ by Jones-Hamilton Co. in Walbridge Ohio. It has been certified as GRAS (Generally Recognized As Safe), and it meets Food Chemicals Codex, 5th Edition Specifications. The sodium acid sulfate is in dry granular crystalline form in particle sizes that can be readily and uniformly dispersed and solubilized in aqueous media. In certain embodiments, the particles having a generally spherical shape with an average diameter from about 0.03 mm to about 1 mm, typically about 0.75 mm. Also, in certain embodiments, the product includes sodium bisulfate in an amount from about 91.5% to about 97.5% by weight (typically about 93%), and sodium sulfate in an amount from about 2.5% to about 8.5% by weight (typically about 7%).

In certain embodiments, the Jones-Hamilton food grade sodium acid sulfate is low in impurities. For example, the product may contain less than about 0.003% heavy metals as Pb, less than about 0.05% water-insoluble substances, and less than about 0.003% selenium by weight. Also, in certain embodiments, the product has a moisture content of less than about 0.8% (measured by loss on drying).

In certain embodiments, the acid component comprises sodium acid sulfate and one or more inorganic acids.

In a particular example, the antimicrobial composition is included in an aqueous solution which comprises from about 5% to about 75% hydrogen peroxide (food grade), from about 0.5% to about 50% sulfuric acid or other inorganic acid(s), and from about 0.3% to about 40% sodium acid sulfate (by weight of the solution), the remainder being water. More particularly, the solution comprises from about 25% to about 55% hydrogen peroxide (food grade), from about 3% to about 15% sulfuric acid, and from about 0.3% to about 10% sodium acid sulfate, the remainder being water.

The acid component is included in the antimicrobial composition in any suitable amount. In certain embodiments, the acid component is included in a solution for application to the food in an amount sufficient to achieve a pH of the solution within a range of from about pH 1 to about pH 10, and more particularly from about pH 1.5 to about pH 8. In a particular example, a blend of sulfuric acid and sodium acid sulfate is used in an amount sufficient to achieve a pH down to about 2.

The oxidizer and the acid component may be combined in a blend before application to the food, or they may be separate before they are applied to the food. For example, the components can be added independently into a solution that is then applied to a food and controlled accordingly, or they can be blended into a solution and then dosed into the process to achieve the desired pH and oxidizer concentrations. In a food processing operation, the components may be added to the process via chemical dosing pump(s) or other means, and the levels may be controlled by use of probes with monitoring systems and controls.

In certain embodiments, the antimicrobial composition consists of the oxidizer and the acid component. In other words, the oxidizer and the acid component are the only components of significance in the antimicrobial composition.

Also, in certain embodiments, the antimicrobial composition excludes any substantial amount of organic acid as contrasted with the inorganic acid(s). Inorganic acids can be much stronger than organic acids, which allows the use of less acid to reach the desired pH. Also, strong acids typically produce salts during neutralization reactions that are normally found in foods, and have a low vapor pressure reducing the tendency of off-gassing like some organic acids.

In other embodiments, the antimicrobial composition additionally comprises one or more surfactants. The surfactant(s) can reduce surface tension on the food, allowing for more thorough wetting. Any suitable surfactant(s) can be used. Some examples of anionic surfactants include C₆₋₁₈ alkyl sulfates and/or sulfonates; C₆₋₁₅ alkylbenzene sulfonates; di-C₆₋₁₀ alkyl sulfosuccinates, etc. Some examples of nonionic surfactants include alkylene oxide adducts of C₆₋₁₈ aliphatic alcohols or acids, polysorbates, and C₁₀₋₁₈ aliphatic alcohol adducts of glucose. The surfactant(s) can be suitable for use in low pH oxidizing environments. Preferably, the surfactant(s) are food grade materials. Numerous types of food grade surfactants are produced by companies such as BASF, Dow, etc. The surfactant(s) are included in any amount suitable for reducing surface tension.

In certain embodiments, the antimicrobial composition consists of the oxidizer, the acid component and the one or more surfactants. In other words, the oxidizer, the acid component and the one or more surfactants are the only components of significance in the antimicrobial composition.

A method of reducing microbes on food according to the invention comprises applying to the food an antimicrobial composition as described above. The food can be any type that would benefit from application of the antimicrobial composition. In certain embodiments, the food is a meat. Some examples of meats include poultry, seafood, beef, pork and sheep. In certain embodiments, the antimicrobial composition is used for microbial reduction on the carcasses and/or parts of meat in a meat processing operation.

In other embodiments, the food is a fruit or vegetable (including legumes). For example, the antimicrobial composition can be applied to whole or parts of fruits or vegetables during their processing. Some particular examples of vegetables are leafy greens such as spinach.

The antimicrobial composition can be applied to the food in any suitable manner. For example, the composition may be applied to the food in a spray or rinse. In certain embodiments, the antimicrobial composition is applied to the food in diluted form. Further, in certain embodiments, the antimicrobial composition is included in an aqueous solution applied to the food during processing. For example, the antimicrobial composition may be included in an aqueous rinse or spray, or it may be injected into an aqueous stream supplying the food processing equipment. In certain embodiments, the antimicrobial composition is used on poultry processing lines in one or more of scalders, sprayers, pre-chill dip systems, immersion chillers, and post-chill dip applications.

For example, in certain embodiments, the antimicrobial composition is added to a poultry processing operation by adding it to the scalder, post-pick spray, online spray, inside/outside bird washer, pre-chill dip, chill, and/or post-chill dip systems using positive displacement metering pumps, at concentrations sufficient to achieve pH's ranging from ambient down to 2.0, depending upon the intervention location. The composition may be monitored continuously using an Endress-Hauser microprocessor controller or PLC based system, utilizing ISFET non-glass pH probes, or other suitable equipment.

In a particular example, for chiller applications, the antimicrobial composition is administered to achieve up to 110 ppm hydrogen peroxide, and the composition includes a blend of sulfuric acid and sodium acid sulfate sufficient to achieve a pH of ambient down to about 2.

### EXPERIMENTATION

Research was done to determine the antimicrobial efficacy of an antimicrobial composition according to the invention on broiler chicken carcasses. The antimicrobial composition is hereinafter referred to as “AHP” (acidified hydrogen peroxide).

Introduction: Studies were conducted to determine the effect of AHP on aerobic plate counts (“APC”), coliform counts and Salmonella incidence on broiler carcasses in a chiller application; and on APC and coliform counts in an on-line reprocessing (“OLR”) application.

Materials and Methods:

Chiller Simulation: Three separate tests were performed using AHP as a simulated chiller treatment. Two 30-gallon sanitized containers were filled to approximately 20 gallons with potable water from the plant and were chilled to approximately 36° F. by immersing sealed plastic bags containing ice (as to not allow for dilution) into each container. The first container was treated with AHP to a pH of 4.0 with a hydrogen peroxide concentration of 100 ppm (Treatment 1). The second container was treated to a pH of 4.0 with a hydrogen peroxide concentration of 250 ppm (Treatment 2). Thirty birds from the same flock were removed from the line pre-chill/post-OLR and hung on sanitized racks. Ten birds, labeled as the “Control” were rinsed with 400 ml of buffered peptone with each rinsate being uniquely numbered and submitted to an outside lab for microbial analysis. Ten birds were removed from the rack and placed in the first test container labeled “100 ppm, and the final 10 birds were placed in the second container labeled “250 ppm”. The birds were gently agitated every 5 minutes in each container with a sanitized PVC paddle specific to each container. Water samples from each container were collected and analyzed for pH and hydrogen peroxide concentration every 15 minutes and adjusted accordingly. After a 90-minute dwell time, the birds were removed from each container and hung on sanitized racks to remove excess water. The birds were then rinsed using 400 ml of buffered peptone with each rinsate being uniquely numbered corresponding to their respective treatment method. The samples were submitted to an outside microbiological laboratory for microbial testing for aerobic plate counts (APC), coliform counts (Coliforms) and Salmonella prevalence. Finally, ten birds were removed from the chiller unloader, hung onto sanitized racks and rinsed with 400 ml of buffered peptone. The rinsate was uniquely numbered and corresponded to the “Hypochlorous” data set. The chiller was being treated with sodium hypochlorite acidified with a commercially approved acidifier to a pH of 5.5-6.5. The results, graphically represented in FIG. 1 (APC), FIG. 2 (coliforms) and FIG. 3 (Salmonella), depict actual loading on birds entering the chiller as well as actual loading on the birds exiting the chiller, as compared to the two simulated AHP treatments.

OLR Simulation: A test was performed to simulate OLR treatment with AHP. Two 30-gallon sanitized containers were filled to approximately 20 gallons with potable water from the plant. The first container was treated to a pH of 2.0 and a hydrogen peroxide concentration of 250 ppm. The second container was treated to a pH of 2.0 and a hydrogen peroxide concentration of 1500 ppm. Thirty birds from the same flock were pulled from the processing line prior to OLR and hung onto sanitized racks. Ten birds were rinsed using 400 ml of buffered peptone with rinsate being uniquely number corresponding to the “Control” sample set, with samples being sent to an outside microbiology laboratory for microbial testing. Ten birds were pulled from the processing line Post-OLR, hung onto sanitized racks to drain excess water and were rinsed with 400 ml of buffered peptone with rinsate being uniquely number corresponding to the “Actual-PAA” sample set. The samples were submitted to an outside microbiological laboratory for microbial testing for aerobic plate counts (APC), coliform counts (coliforms) and Salmonella prevalence. The remaining 20 untreated birds were individually immersed into an AHP treated container for 10 seconds (10 birds each immersed in the 250 ppm solution and 10 birds in the 1500 ppm solution) to mimic the actual OLR, which contains a dip tank followed by a spray cabinet. After the 10 second dip, each bird was placed onto a sanitized rack to allow excess water to drain from the bird. Each bird was rinsed using 400 ml of buffered peptone with rinsate being uniquely number corresponding to the respective “250 ppm ” or “1500 ppm” sample set, with samples being sent to an outside lab for microbial testing. The results, graphically represented in FIG. 4, represent actual microbial loading into the OLR as well as actual loading post OLR when treated with PAA, as compared to the simulated treatment with two variations of AHP.

Statistical Analysis: Data for APC and E. coli were converted to log₁₀ values and were subjected to one-tail tests. The P-values in all cases are for one-tail tests, testing that the treatment (either Treatment 1 or Treatment 2) is better (lower level of contamination in log₁₀ scale) than the Control. For Salmonella, Chi-Square analysis was used.

Results and Discussion:

Aerobic plate counts (log₁₀cfu/mL) for broiler carcasses chilled in tap water, 100 ppm AHP, 250 ppm AHP, or Hypochlorous acid are depicted graphically in FIG. 1.

Coliform counts (log₁₀cfu/mL) for broiler carcasses chilled in tap water, 100 ppm AHP, 250 ppm AHP, or Hypochlorous acid are depicted graphically in FIG. 2.

For APC and E. coli, for all 3 days and overall, for both treatments, the null hypothesis of equal contamination is rejected in favor of the alternative that the treatment is better. Although both are significant at alpha=0.05, Treatment 2 seems to be even better (more significant) than Treatment 1, although they were not evaluated versus one another. Overall, AHP seems to perform similar to pH controlled hypochlorous acid, but significantly lowered APC and coliforms when compared to controls.

Salmonella incidence (%) for broiler carcasses chilled in tap water, 100 ppm AHP, 250 ppm AHP, or Hypochlorous acid are depicted graphically in FIG. 3.

For Salmonella, there were too few observations to find any statistically significant conclusion. In 4 of the 8 tests, the direction was as suspected (treatment better than control), in 2 they were tied, and in 2 control was better than treatment, but in none of the 6 separate tests or the 2 combined tests was there any evidence of statistical superiority one way or the other.

Coliform counts and total plate counts (TPC) for the results of the OLR simulation are shown graphically in FIG. 4. In this study, AHP at 250 or 1500 ppm performed significantly better than peracetic acid or controls. Interestingly, 250 ppm of AHP performed better than 1500 ppm.

In conclusion, AHP should be a useful, cost effective processing aid for the poultry industry and compares well to the most commonly used processing aids such as chlorine (hypochlorous acid) in chilling applications and peracetic acid in an OLR spray application.

Research was also done to determine the efficacy of an antimicrobial composition according to the invention on whole and fresh-cut produce, to lower the risk of pathogenic microbes on the produce without the changes in flavor associated with other food antimicrobials, and to improve the shelf life of the produce.

In a trial with Granny Smith apples, antimicrobial solutions according to the invention were tested that included a combination of 1% sodium acid sulfate with 50 ppm peroxyacetic acid in water, or a combination of 1% sodium acid sulfate with 1000 ppm hydrogen peroxide in water. These were compared with other food antimicrobial solutions not according to the invention, and compared with heating to reduce microbes.

The apples were cored and sliced into six slices per apple. The apples were dipped in the antimicrobial solutions for 1 to 3 minutes and then stored in sealed bags at 45° F. in a refrigerator and taken out for testing at appropriate times. Testing showed that all the dips improved the microbial counts. However, the color of apples dipped in the antimicrobial solutions of the invention color was significantly better than apples dipped in the other solutions or exposed to heating.

In a trial with spinach, antimicrobial solutions according to the invention were tested that included a combination of 0.5% sodium acid sulfate with 100 ppm peroxyacetic acid in water. These were compared with other food antimicrobial solutions not according to the invention.

In this study, we used petite spinach. The spinach was dipped for a time between 1 and 3 minutes in the different solutions. In all cases a 100 gm sample was sealed in a 50 OTR bag. The testing results showed that the antimicrobial solutions according to the invention resulted in the spinach having good chemical and organoleptic ratings as well as greatly diminished microbial numbers. It is clear that the compositions can be useful for the treatment of leafy greens such as spinach, especially to reduce microbial growth.

In summary, the studies showed that the antimicrobial compositions of the invention can be effective to extend the life of whole and fresh-cut produce, and to improve the quality and the microbial safety of these products.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A method of reducing microbes on food comprising applying to the food an antimicrobial composition comprising an oxidizer and an acid component, the oxidizer comprising hydrogen peroxide and/or peroxyacetic acid, and the acid component comprising one or more inorganic acids or their salts.

2. The method of claim 1 wherein the antimicrobial composition is applied to meat during processing of the meat.

3. The method of claim 2 wherein the meat is poultry.

4. The method of claim 1 wherein the antimicrobial composition is applied to vegetables during processing of the vegetables.

5. The method of claim 4 wherein the vegetables are leafy greens.

6. The method of claim 1 wherein the antimicrobial composition is applied to fruits during processing of the fruits.

7. The method of claim 1 wherein the antimicrobial composition is included in an aqueous solution applied to the food during processing.

8. The method of claim 7 wherein the oxidizer is hydrogen peroxide included in an amount within a range of from about 10 ppm to about 2500 ppm of the solution.

9. The method of claim 7 wherein the acid component is included in an amount sufficient to achieve a pH level of the solution within a range of from about pH 1 to about pH 9.

10. The method of claim 1 wherein the antimicrobial composition additionally comprises one or more surfactants.

11. A method of reducing microbes on food comprising applying to the food an aqueous solution including an antimicrobial composition comprising hydrogen peroxide and an acid component, the acid component comprising sodium acid sulfate and one or more inorganic acids, the solution comprising from about 5% to about 75% hydrogen peroxide, and from about 0.3% to about 40% sodium acid sulfate, and from about 0.5% to about 50% inorganic acid, the remainder being water.

12. The method of claim 11 wherein the solution comprises from about 25% to about 55% hydrogen peroxide, from about 0.3% to about 10% sodium acid sulfate, and from about 3% to about 15% sulfuric acid, the remainder being water.
